(19) United States
(12) Patent Application Publication
(10) Pub. No.: US 2016/0309921 A1
(43) Pub. Date: Oct. 27, 2016

(54) Support Tube End Clip For A Collapsible Display

(71) Applicant: Terry J. Krause, Racine, WI (US)

(72) Inventor: Terry J. Krause, Racine, WI (US)

(21) Appl. No.: 14/694,284

(22) Filed: Apr. 23, 2015

(51) Int. Cl. A47F 5/13; A47F 5/00; F16B 12/42; F16B 9/02

(52) U.S. Cl. CPC A47F 5/13; F16B 9/023; A47F 5/0018; F16B 12/42

(57) ABSTRACT

A support tube end clip preferably includes an insertion portion and a support portion. The insertion portion includes a fin tube, a flange and a plurality of flexible fins. The tube extends from one side of the flange. The plurality of flexible fins extend outward from an outer perimeter of the fin tube. The support portion preferably includes a support projection, a retention tab and a gusset. A second embodiment of the support tube end clip includes the insertion portion and an extended support portion. One support tube end clip is inserted into each end of an elongated tube. A plurality of support slots are formed in the opposing walls of the collapsible display for a plurality of shelves to receive the support tube end clip.

### BACKGROUND OF THE INVENTION

1. Field of the Invention

The present invention relates generally to collapsible displays and more specifically to a support tube end clip for a collapsible display, which allows a nonmetallic tube to support a shelf of the collapsible display.

2. Discussion of the Prior Art

U.S. Pat. No. 1,895,725 to Nuckols discloses a collapsible display stand. U.S. Pat. No. 3,863,575 to Kuns et al. discloses a display stand. U.S. Pat. No. 4,582,003 to Valero discloses a folding corrugated board display shelving. U.S. Pat. No. 8,496,126 to Mueller et al. discloses a shelving system. It is common to use a metal support rod in collapsible displays, similar to that disclosed in the Kuns et al. patent. The metal support rod can be manufactured from a single piece of metal material. However, in the state of Virginia, state law forbids the use of metal support rods in temporary displays.

Accordingly, there is a clearly felt need in the art for a support tube end clip for a collapsible display, which allows a nonmetallic tube to support a shelf of the collapsible display.

### SUMMARY OF THE INVENTION

The present invention provides a support tube end clip for a collapsible display, which allows a nonmetallic tube to support a shelf of a collapsible display. The support tube end clip preferably includes an insertion portion and a support portion. The insertion portion includes a fin tube, a flange and a plurality of flexible fins. The fin tube extends from one side of the flange. The plurality of flexible fins extend outward from an outer perimeter of the fin tube. The support portion preferably includes a support projection, a retention tab and a gusset. The support projection extends from an opposing side of the flange. The retention tab extends downward from a distal end of the support projection. The gusset is formed between opposing side of the flange and a top of the support projection. A second embodiment of the support tube end clip includes the insertion portion and an extended support portion. The extended support portion includes an extended support projection, a retention tab and a gusset. The extended support projection extends from a bottom of the flange. The retention tab extends downward from a distal end of the extended support projection. The gusset is formed between opposing side of the flange and a top of the extended support projection.

One support tube end clip is inserted into each end of an elongated tube. A length of the elongated tube is shorter than an inside distance between opposing walls of a collapsible display. A plurality of support slots are formed in the opposing walls of the collapsible display for a plurality of shelves to receive the support tube end clip.

Accordingly, it is an object of the present invention to provide a support tube end clip for a collapsible display, which allows a nonmetallic tube to support a shelf of an collapsible display.

These and additional objects, advantages, features and benefits of the present invention will become apparent from the following specification.

### BRIEF DESCRIPTION OF THE DRAWINGS

FIG. 1 is an end view of a support tube end clip for a collapsible display in accordance with the present invention.

FIG. 2 is a side view of a support tube end clip for a collapsible display in accordance with the present invention.

FIG. 3 is an end view of a second embodiment of a support tube end clip for a collapsible display in accordance with the present invention.

FIG. 4 is a cross sectional side view of a second embodiment of a support tube end clip for a collapsible display cut through FIG. 3 in accordance with the present invention.

FIG. 5 is a front cross sectional view of a support tube and end clips retained in opposing walls of a collapsible display in accordance with the present invention.

FIG. 6 is an end view of an end clip retained in a support slot of a side wall of a collapsible display cut through FIG. 5 in accordance with the present invention.

FIG. 7 is a front cross sectional view of a second embodiment of a support tube and end clips retained in opposing walls of a collapsible display in accordance with the present invention.

FIG. 8 is a cross sectional view of a support tube and end clip retained in a support slot of a side wall of a collapsible display cut through FIG. 7 in accordance with the present invention.

FIG. 9 is a top cross sectional view of a shelf retained in a collapsible display supported by a support tube and end clips in accordance with the present invention.

FIG. 10 is a cross sectional view of a shelf retained in a collapsible display supported by a support tube and end clips, cut through FIG. 9 in accordance with the present invention.

### DETAILED DESCRIPTION OF THE PREFERRED EMBODIMENTS

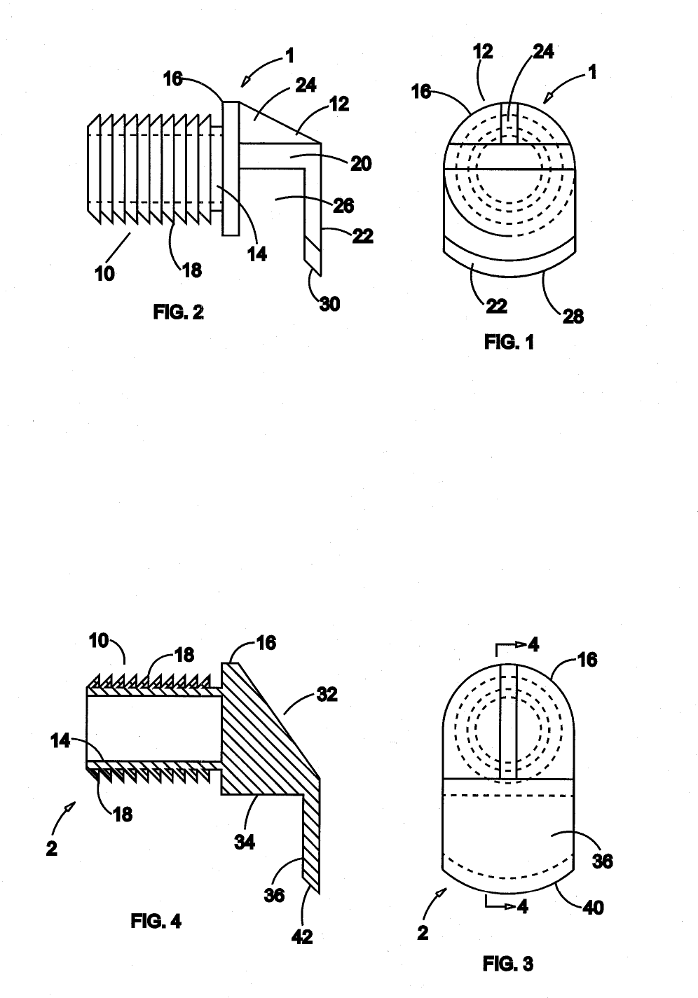

With reference now to the drawings, and particularly to FIG. 1, there is shown an end view of a support tube end clip 1. With reference to FIG. 2, the support tube end clip 1 preferably includes an insertion portion 10 and a support portion 12. The insertion portion 10 includes a fin tube 14, a flange 16 and a plurality of flexible fins 18. The fin tube 14 extends from one side of the flange 16. The plurality of flexible fins 18 extend outward from an outer perimeter of the fin tube 16. The support tube end clip 1 is fabricated from a plastic having resilient properties to allow the plurality of flexible fins 18 to flex. The support portion 12 preferably includes a support projection 20, a retention tab 22 and a gusset 24. The support projection 20 extends from an opposing side of the flange 16. The retention tab 22 extends downward from a distal end of the support projection 20. A wall slot 26 is formed between the opposing side of the flange 16 an inside surface of the retention tab 22. The gusset 24 is formed between the opposing side of the flange 16 and a top of the support projection 20. A curved surface 28 is preferably formed on a bottom of the retention tab 22. An inward chamfer 30 is also formed on a bottom of the retention tab 22 and on an inside surface thereof. The curved surface 28 and the inward chamfer 30 facilitate insertion through a support slot in a side wall of a collapsible display.

With reference to FIGS. 3-4, a second embodiment of the support tube end clip 2 includes the insertion portion 10 and an extended support portion 32. The extended support portion 32 preferably includes an extended support projection 34, a retention tab 36 and a gusset 38. The extended support projection 34 extends from a bottom and an opposing side of the flange 16. The retention tab 36 extends downward from a distal end of the extended support projection 34. The gusset 38 is formed between the opposing side of the flange 16 and a top of the extended support projection 34. A curved surface 40 is preferably formed on a bottom of the retention tab 36. An inward chamfer 42 is also formed on a bottom of the retention tab 36 and on an inside surface thereof. The curved surface 40 and the inward chamfer 42 facilitate insertion through a support slot in a side wall of a collapsible display.

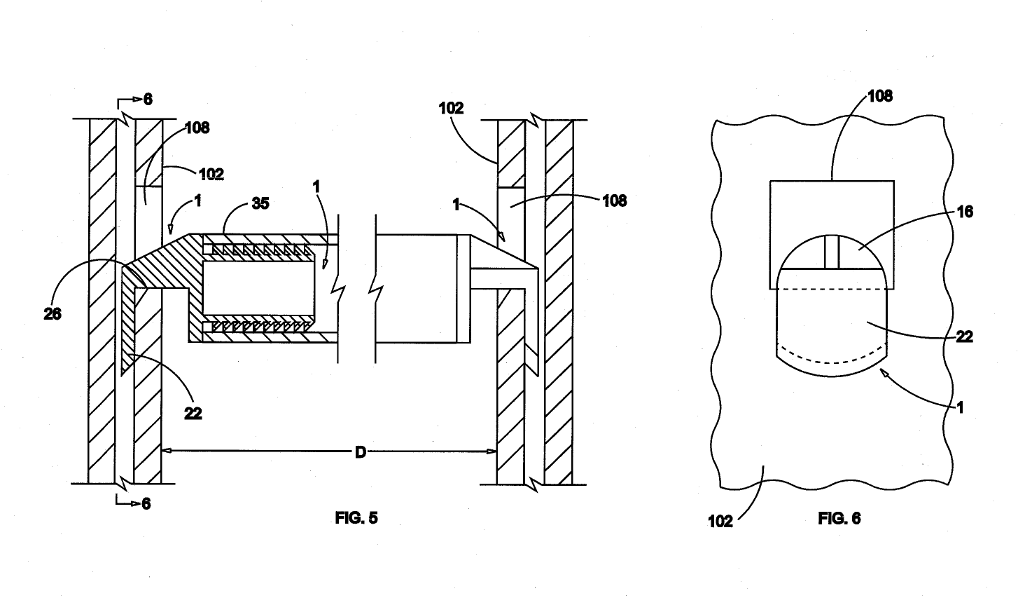

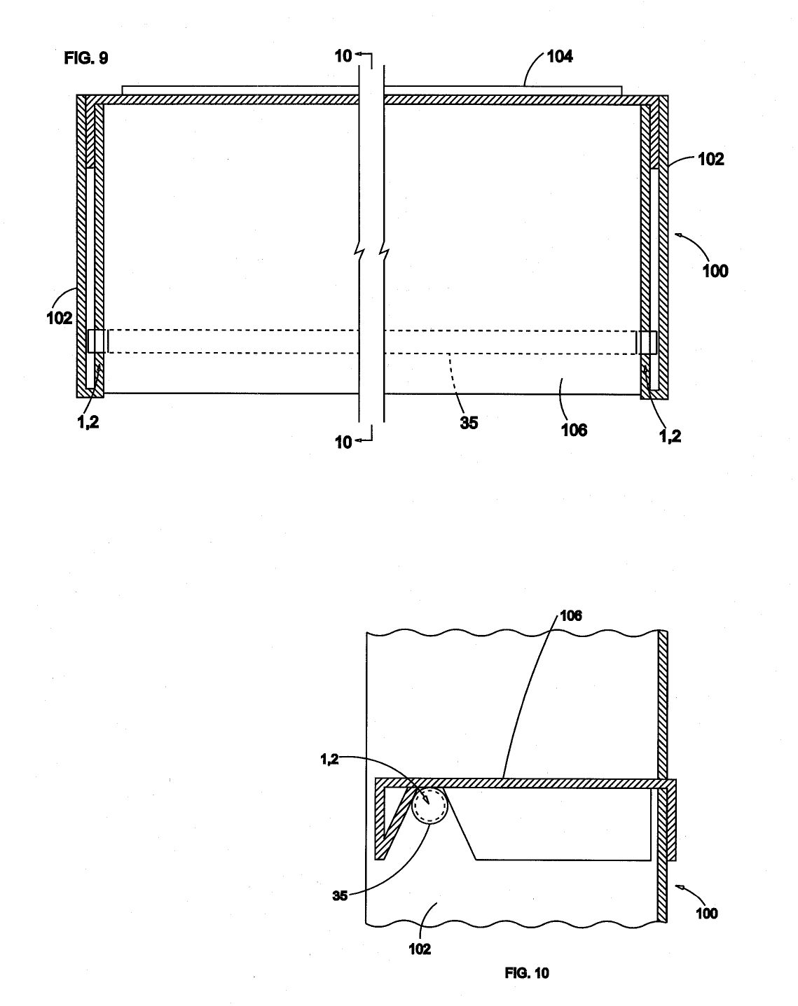

With reference to FIGS. 5-6 and 9-10 one support tube end clip 1 is inserted into each end of an elongated tube 35. The elongated tube 35 may have any suitable wall thickness dependent upon the strength needed to support a shelf load. A collapsible display 100 includes two opposing side walls 102, a rear wall 104 and a plurality of shelves 106. The two opposing side walls 102, the rear wall 104 and the plurality of shelves 106 are preferably fabricated from corrugated cardboard. The corrugations in the two opposing side walls 102 are aligned in a vertical orientation, similar to a column. The corrugations in the shelf are aligned to be parallel with a lengthwise axis of the elongated tube 35. A length of the elongated tube 35 is slightly shorter than an inside distance “D” between the opposing side walls 102 of the collapsible display 100. A plurality of support slots 108 are formed through the opposing side walls 102 of the collapsible display 100 to receive the support tube end clips 1. A width of the wall slot 26 is sized to receive a thickness of the side wall 102.

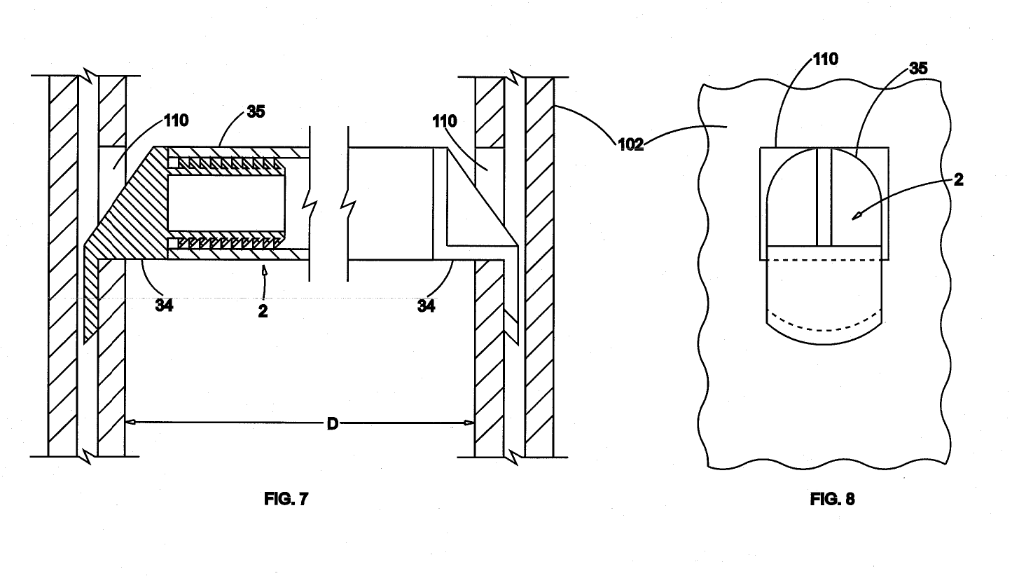

With reference to FIGS. 7-8, one support end clip 2 is inserted into each end of the elongated tube 35. The length of the elongated tube 35 is shorter than an inside distance “D” between the opposing side walls 102 of the collapsible display 100. A plurality of support slots 110 are formed through the opposing side walls 102 of the collapsible display 100 to receive the support tube end clips 2.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A support tube end clip for a collapsible display, the collapsible display including two opposing side walls and at least one elongated tube for support of at least one shelf, the at least one shelf supports at least one object, comprising:
an insertion portion includes a fin tube, a flange and a plurality of flexible fins, said fin tube extends from one side of said flange, said plurality of flexible fins extend outward from an outer perimeter of said fin tube;
a support projection extends from an opposing side of said flange, a width of said support projection is at least as wide as a width of said plurality of flexible fins, wherein said insertion portion is capable of being inserted into either end of the elongated tube, said support projection of said support tube end clip is capable of being engaged with one of the opposing side walls of the collapsible display, the elongated tube supports the weight of a shelf with at least one object placed thereupon relative to the opposing side walls of the collapsible display.

2. The support tube end clip for a collapsible display of claim 1 wherein:
a retention tab extends downward from a distal end of said support projection, a wall slot is formed between said opposing side of said flange and an inside surface of said retention tab, wherein said wall slot is sized to receive a thickness of one of the two opposing side walls.

3. The support tube end clip for a collapsible display of claim 2 wherein:
a chamfer is formed on an inside surface of said retention tab at a bottom thereof.

4. The support tube end clip for a collapsible display of claim 2 wherein:
a rounded shape is formed on a bottom of said retention tab.

5. (canceled)

6. The support tube end clip for a collapsible display of claim 1 wherein:
said support projection extends from a bottom and said opposing side of said flange, said retention tab extends downward from a distal end of said support projection.

7. (canceled)

8. A support tube end clip for a collapsible display, the collapsible display including two opposing side walls and at least one elongated tube for support of at least one shelf, the at least one shelf supports at least one object, comprising:
an insertion portion includes a fin tube, a flange and a plurality of flexible fins, said fin tube extends from one side of said flange, said plurality of flexible fins extend outward from an outer perimeter of said fin tube; and
a support projection extends from an opposing side of said flange, a bottom of said support projection is located below a to of said plurality of flexible support fins and above a bottom of said plurality of flexible support fins,
wherein said insertion portion is capable of being inserted into either end of the elongated tube, said support projection of said support tube end clip is capable of being engaged with one of the opposing side walls of the collapsible display, the elongated tube supports the weight of the shelf with at least one object placed thereupon relative to the opposing side walls of the collapsible display.

9. The support tube end clip for a collapsible display of claim 8 wherein:
a retention tab extends downward from a distal end of said support projection, a wall slot is formed between said opposing side of said flange and an inside surface of said retention tab, wherein said wall slot is sized to receive a thickness of one of the two opposing side walls.

10. The support tube end clip for a collapsible display of claim 9 wherein:
a chamfer is formed on an inside surface of said retention tab at a bottom thereof.

11. The support tube end clip for a collapsible display of claim 9 wherein:
a rounded shape is formed on a bottom of said retention tab.

12-14. (canceled)

15. A support tube end clip for a collapsible display, the collapsible display including two opposing side walls and at least one elongated tube for support of at least one shelf, the at least one shelf supports at least one object, comprising:
an insertion portion includes a fin tube, a flange and a plurality of flexible fins, said fin tube extends from one side of said flange, said plurality of flexible fins extend outward from an outer perimeter of said fin tube;
a support projection extends from an opposing side of said flange, a bottom of said support projection is located below a top of said plurality of flexible support fins and above a bottom of said plurality of flexible support fins, a gusset is formed between said opposing side of said flange and a top of said support projection, wherein said insertion portion is capable of being inserted into either end of the elongated tube, said support portion of said support tube end clip is capable of being engaged with one of the two opposing side walls of the collapsible display, the elongated tube supports the weight of a shelf with the at least one object placed thereupon relative to the opposing side walls.

16. The support tube end clip for a collapsible display of claim 15 wherein:
a retention tab extends downward from a distal end of said support projection, a wall slot is formed between said opposing side of said flange and an inside surface of said retention tab, wherein said wall slot is sized to receive a thickness of one of the two opposing side walls.

17. The support tube end clip for a collapsible display of claim 16 wherein:
a chamfer is formed on an inside surface of said retention tab at a bottom thereof.

18. The support tube end clip for a collapsible display of claim 16 wherein:
a rounded shape is formed on a bottom of said retention tab.

19-20. (canceled)
